(19) United States
(12) Patent Application Publication
(10) Pub. No.: US 2020/0167238 A1
(43) Pub. Date: May 28, 2020

(54) SNAPSHOT FORMAT FOR OBJECT-BASED STORAGE

(71) Applicant: HEWLETT PACKARD ENTERPRISE DEVELOPMENT LP, Houston, TX (US)

(72) Inventors: Praveen KILLAMSETTI, San Jose, CA (US); Ricardo LABIAGA, San Jose, CA (US); Monil Mukesh SANGHAVI, San Jose, CA (US); Shrikant Pramod METHER, San Jose, CA (US); Ammar Govind EKBOTE, San Jose, CA (US)

(73) Assignee: HEWLETT PACKARD ENTERPRISE DEVELOPMENT LP, Houston, TX (US)

(21) Appl. No.: 16/226,197

(22) Filed: Dec. 19, 2018

Related U.S. Application Data
(60) Provisional application No. 62/770,978, filed on Nov. 23, 2018.

(51) Int. Cl. G06F 11/14

(52) U.S. Cl. CPC G06F 11/1451; G06F 2201/84; G06F 11/1461

(57) ABSTRACT

According to examples, an apparatus may include a processor that may store copies of full and incremental snapshots of a volume to an object-based storage system in a format that may include a volume object, a plurality of snapshot objects, and a plurality of data bucket objects. The volume object may point to each of the snapshot objects that each correspond to a snapshot created for the volume. Each of the snapshot objects may have a list of one or more of the data bucket objects for the corresponding snapshot, in which, for incremental snapshots, the corresponding snapshot object points to identifications of data bucket objects that represent changes made to the data in the volume since a prior snapshot and each data bucket object may have a list of a data block including data representing the snapshot corresponding to the snapshot object pointing to the data bucket object.

### CROSS-REFERENCE TO RELATED APPLICATIONS

This application claims priority to U.S. Provisional Patent Application No. 62/770,978, filed on Nov. 23, 2018, entitled “SNAPSHOT FORMAT FOR OBJECT-BASED STORAGE,” the content of which is incorporated by reference in its entirety herein.

### BACKGROUND

Storage systems may be used for a variety of purposes including access to shared data by multiple users and data storage. Storage systems may include storage devices that are collocated with each other and/or located at multiple locations. Data stored at storage devices may be replicated and the replicated copies of the data may be stored on multiple storage devices to safeguard against the failure of a single storage device. As such, when a storage device fails or the data in the storage device is inadvertently erased or edited, a copy of the desired data may be retrieved from another storage device.

### BRIEF DESCRIPTION OF THE DRAWINGS

Features of the present disclosure may be illustrated by way of example and not limited in the following figure(s), in which like numerals indicate like elements, in which:

FIG. 1A shows a block diagram of an example apparatus that generates snapshots for copying to an object-based storage system;

FIG. 1B shows a block diagram of an example snapshot object controller that generates snapshots for copying to an object-based storage system;

FIG. 2 shows a block diagram of an example system for generating full and incremental snapshots of a storage volume;

FIG. 3 shows a block diagram of an example object-based snapshot format for storing full and incremental snapshots of a storage volume in an object-based storage system;

FIG. 4 depicts a flow diagram of an example method for generating a full snapshot for copying to an object-based storage system;

FIG. 5 depicts a flow diagram of an example method for generating a delta snapshot for copying to an object-based storage system;

FIG. 6 depicts a flow diagram of an example method for generating a synthetic snapshot for copying to an object-based storage system;

FIG. 7 depicts a flow diagram of an example method for deleting synthetic snapshots for garbage collection operations in an object-based storage system;

FIG. 8 depicts a block diagram of an example non-transitory machine-readable storage medium for generating snapshots for copying to an object-based storage system.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” may be intended to denote at least one of a particular element. As used herein, the term “includes” means includes but not limited to, the term “including” means including but not limited to. The term “based on” means based at least in part on.

Disclosed herein are apparatuses and methods for efficiently storing full and incremental backup data (snapshots) that represent a state of a local volume of data in an object-based storage system such as a remote cloud storage system. Snapshots may be stored in a format that enables integration with object-based storage systems and restoration to any local storage volume. Particularly, for instance, the data format includes an object-related data model that models a volume being backed up as a volume object that points to snapshot data objects. Each snapshot data object may represent a snapshot of the volume and may point to data bucket objects that store lists of data blocks that include snapshot data. Snapshots may include shared data blocks, which may be inherited from a predecessor snapshot to a successor snapshot, enhancing data storage efficiency and garbage collection.

In various examples, each snapshot object may include self-describing metadata that enables dependency-free restoration on local volumes from object-based snapshot data stored in the object-based storage system. The self-describing metadata may also enable efficient location of data bucket objects and corresponding data without having to read such data, which can be an expensive I/O operation. The metadata may permit minimization of I/O costs by facilitating the examination of data buckets without actually reading underlying data blocks, which may require egress of the data from object-based storage. As such, I/O costs associated with access and garbage collection operations on the snapshot data are minimized, enabling efficient backup operations to the cloud and other object-based storage solutions. In some examples, a catalog may be generated based on the metadata. For instance, the catalog may provide searchable data to enable efficient location of backed up data. In a particular example, application specific metadata may be stored in a catalog. The application specific metadata may be used to search a snapshot using search parameters such as a Virtual Machine (“VM”) name or database names that was backed up. In this manner, a user may search for snapshots by VM name, database name, and/or other search parameters. Responsive to the search, the system may return a selectable list of snapshots that meet the search parameter(s). The user may then select one or more of the snapshots from the list for restoration.

Storage, retrieval, and garbage collection may further be enhanced through a hybrid model of generating incremental snapshots. For example, both a delta incremental snapshot and a synthetic snapshot may be used to achieve balanced performance and efficiency. Delta incremental snapshots may store only differences from a prior snapshot (and therefore may be condensed) and may be stored as discontinuous data blocks. Synthetic snapshots may store actual changed data since a prior snapshot and may be stored as continuous data blocks logically aligned to how they are stored, plus pointers to data blocks of a prior snapshot whose data remains unchanged. Thus, consolidation of data blocks from synthetic snapshots may be avoided, which may eliminate expensive read operations and may avoid additional costs on deletes. Furthermore, unlike recovery of delta snapshots, recovery of synthetic snapshots may not require restoration of a prior full or synthetic snapshot. Because delta and synthetic snapshots each have their advantages and disadvantages, the system disclosed herein may use a hybrid model of using both at appropriate times to further enhance efficiency.

A snapshot object controller may interface with a volume manager of a target volume, which may use one or more of various types of filesystems. The snapshot object controller may understand how the snapshots of the target volume are laid out on block storage device(s) (e.g., hard disk drive(s) (HDDs) and/or solid state drive(s) (SSDs), or the like) and may convert the data and metadata objects of the snapshots into a self-describing object-based snapshot format that includes data objects and indexes that are copied to the object-based storage system. The snapshot object controller may also archive snapshots of the object-based storage system based on a snapshot schedule, which may be provided by a system user.

The object-based snapshot format may include a hierarchically arranged set of objects. The data included in each of the objects may be compressed prior to saving them to the object-based storage. When supported by the object-based storage, in some examples, the data may be encrypted. The self-describing format may indicate the compression technique used so that data may be de-compressed through appropriate techniques. The object-based snapshot format may include a volume object that includes metadata information and pointers to snapshot objects.

Each snapshot object may include metadata information that describes the snapshot and indexes to one or more data blocks. Data may be shared between snapshots. As such, each snapshot object may indicate other snapshot objects from which the snapshot object inherits data. It should be noted that each snapshot object may include a reference to data bucket object(s) storing data for particular regions of the target volume pertaining to the snapshot and not all other data for the volume. Each snapshot object may point to data bucket objects that each list one or more data blocks.

A data bucket object may include data up to a certain limit, such as 1 megabyte (MB). Other limits may be used as well. As previously noted, the data itself may be stored in compressed form. The object-based snapshot format may use different types of data bucket objects. In one example, a data bucket object may include a continuous set of blocks that belongs to a given 1 MB (or other size) logical offset range of the target volume. In this example, the snapshot is divided into 1 MB chunks and each allocated 1 MB region of the target volume may be backed up as a data bucket object. Full and synthetic delta backups may use this type of data bucket object.

In another example, a data bucket object may include a discontinuous set of blocks that belong to a snapshot (also referred to as a “delta data bucket object”). A single delta data bucket object may include a delta between two snapshots. This type of data bucket object may be used by delta snapshots. This object may reduce write amplification if a small range of data is modified in 1 MB chunk of the volume space (since the entire 1 MB chunk is not required to be uploaded/copied if only a small change to the 1 MB chunk is made).

As previously noted, different types of snapshots may be generated. For example, the snapshot object controller may generate a full snapshot, a delta snapshot, and/or a synthetic snapshot. A full snapshot may include an initial backup that may be triggered on configuring archiving of the target volume to the object-based storage system. This backup process may copy the entire contents of the target volume. As such, the I/O cost and fees for the backup and time to completion is proportional to the total data to be backed up. This backup workflow finds all in-use 1 MB chunks of the target volume by walking through metadata and sending compressed data to cloud. The snapshot object controller may also understand zero-pattern detection and replace the data with simple headers for better space efficiency. Restoring the data from a full snapshot may involve obtaining all data bucket objects associated with the snapshot and writing the corresponding data blocks to a restored volume.

A delta snapshot may be an incremental backup that includes only difference data from a prior snapshot. As such, a delta snapshot may be condensed and may be used for periodic backups such as daily backups. The size of a delta snapshot is directly proportional to change rate. No additional write amplification occurs depending on the minimum size, such as 1 MB, of an object-based storage system object. Restoration based on a delta snapshot may require restoration of a full or synthetic snapshot and replaying all of the deltas in the delta snapshot.

A synthetic snapshot is another type of an incremental backup. A synthetic snapshot may include an entire 1 MB (or other size) chunk of data even if a small portion of that 1 MB data chunk is changed from the prior synthetic snapshot. As such, synthetic snapshots may be triggered when locked space in incremental backups should be freed due to overwrites (such as when the change rate/number of overwrites or delta snapshot generation on the target volume is high or otherwise exceeds a respective predefined overwrite threshold rate or predefined delta count threshold) or to limit total time to restore an incremental backup. In some instances, the system may automatically (without user intervention) determine that a synthetic snapshot be generated instead of a delta snapshot based on the triggering event (such as when the change rate or delta snapshot generation on the target volume is high). Use of synthetic snapshots may limit the restore cost of a backup because the synthetic snapshots may each have all the information needed for the restoration. As such, the system may avoid restoring a full backup. The first synthetic backup in the volume is in essence a full volume. Synthetic snapshots may also provide a way to delete overwritten data (for garbage collection operations) without reading actual data from the object-based storage system. The synthetic snapshot also may limit the cost of a backup proportional to the change rate if triggered based on an overwrite ratio.

In examples, snapshots may be deleted, which may be based on a retention schedule set by a system user, on-demand, and/or based on other snapshot deletion triggers. Snapshot deletion may trigger garbage collection to free up the space locked by the snapshots. A garbage collection process may read snapshot data in the object-based snapshot format for the snapshot being deleted and successor snapshots from the object-based storage system. The garbage collection process may walk through index objects from these snapshots and may identify the difference between metadata indexes. Based on these differences, the garbage collection process may identify and cause deletion of data objects that are not inherited by the successor snapshot. The successor snapshot object may be modified with data objects that it inherits resulting from the garbage collection process.

In various examples, delta snapshots may be deleted efficiently. In some examples, delta snapshots may be deleted based on certain conditions being met. For instance, delta snapshots may be deleted only if a synthetic snapshot has been created after the current delta snapshot. A delta snapshot may be deleted if a synthetic delta snapshot exists both before and after the delta snapshot has been generated. Deletion of a delta snapshot may involve deleting all snapshot and data objects corresponding to the delta snapshot. Such deletion may be driven by a delete request that specifies the delta snapshot to be deleted, based on a user requirement, and/or retention schedule.

As used herein “snapshot” may refer to a representation of a volume of data at a particular point in time. For example, a data source and applications operating on data being housed in the data source may store a representation of the state of the data as it exists at a particular point in time as a snapshot. A “data source” may refer to a volume or collection of volumes that house data (e.g., for applications). An “application” may refer to a set of software instructions, a service, or a system that may interact with data housed at the data source.

As used herein, an input/output (I/O) may refer to an operation that may alter (e.g., create, delete, or modify) data housed in a data source or volume. Examples of I/O operations may include writes, reads, and deletes.

As used herein, a “volume” may refer to a logical unit of data storage (e.g., a logical unit number (LUN)), wherein data in the volume may be stored on one or more physical storage devices (e.g., HDDs, SSDs, etc., or a combination thereof). In some examples, an “object-based storage system” may be a remote object-based storage system, in that the object-based storage system is “remote” from a primary storage system (e.g., storage array(s)) including the volume(s) from which snapshots are taken and archived on the object-based storage system. In examples described herein, an object-based storage system (e.g., a remote object-based storage system) may not be local to (or locally attached to) the primary storage system, but may instead be accessible to the primary storage system via a computer network such as, for example, a local area network (LAN), a virtual LAN (VLAN), a wireless local area network (WLAN), a virtual private network (VPN), the Internet, or the like, or a combination thereof. In some examples, the object-based storage system may be a “cloud” storage system (or cloud-based storage system herein) that is remote from the deduplication system (e.g., using object-based storage). In examples described herein, an object-based storage system (e.g., a cloud storage system) may be implemented by at least one computing device.

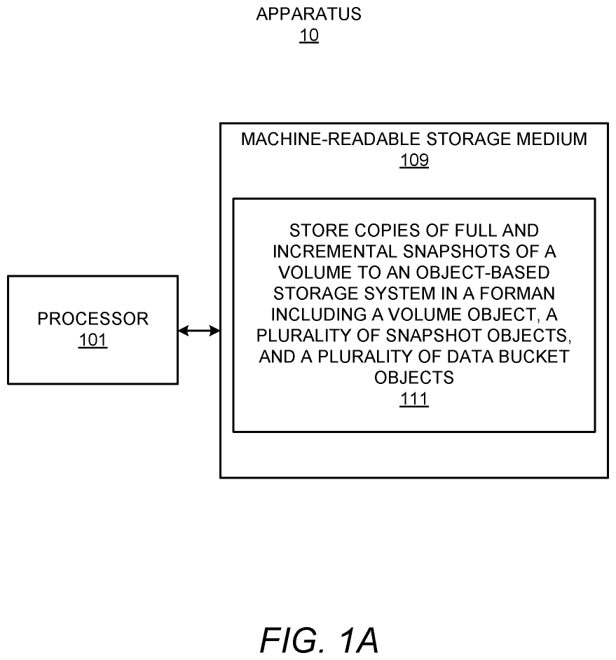

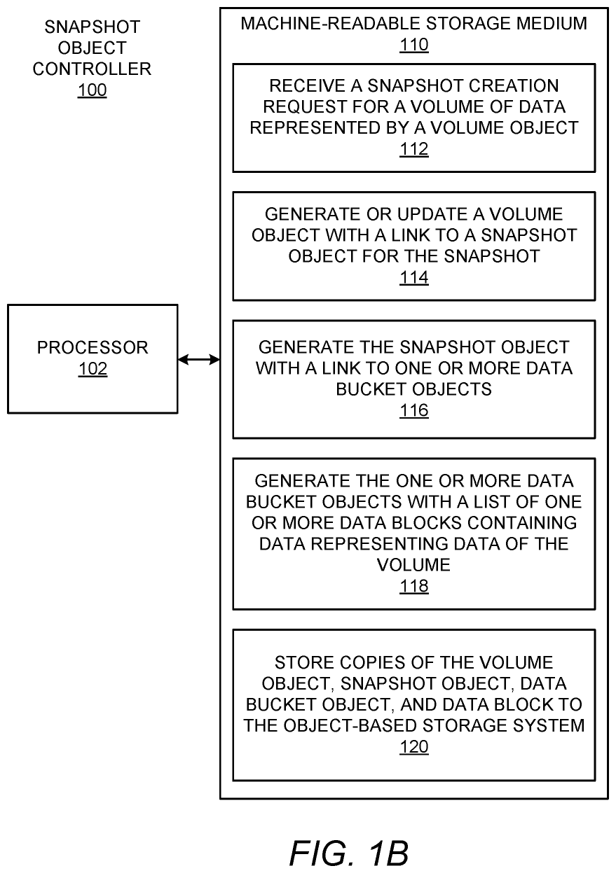

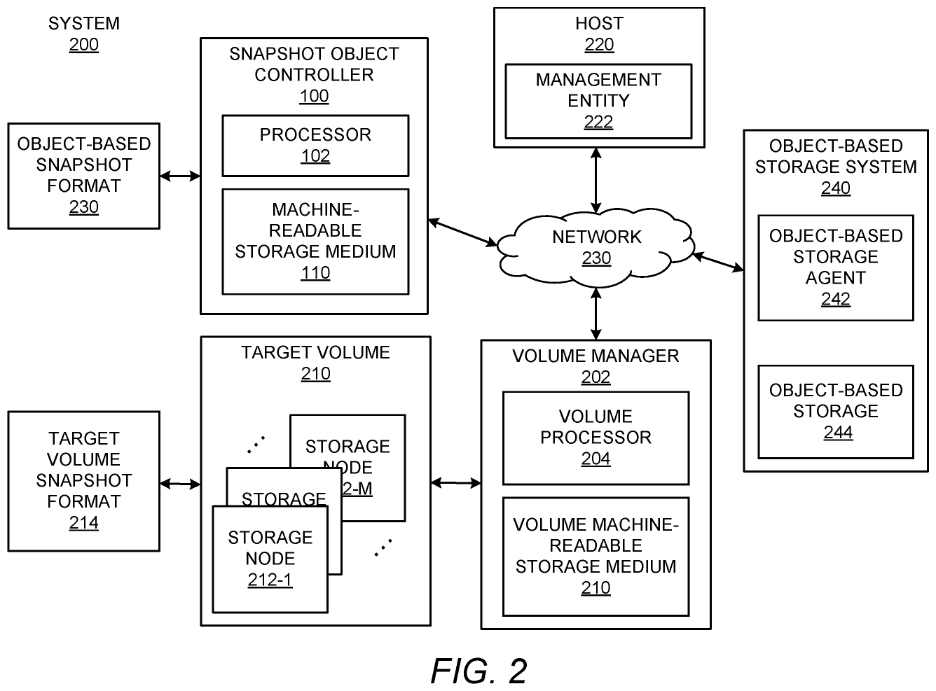

Reference is first made to FIGS. 1A, 1B, and 2. FIG. 1A shows a block diagram of an example apparatus 10 and FIG. 1B shows a block diagram of an example snapshot object controller 100 that may generate snapshots for copying to an object-based storage system. FIG. 2 shows a block diagram of an example system 200 for generating full and incremental snapshots of a storage volume. It should be understood that the example apparatus 10, the example snapshot object controller 100, and the example system 200 respectively depicted in FIGS. 1A, 1B, and 2 may include additional features and that some of the features described herein may be removed and/or modified without departing from any of the scopes of the example apparatus 10, the example snapshot object controller 100, or the example system 200.

The apparatus 10, the snapshot object controller 100, and the volume manager 202 (FIG. 2) may each be a computing device, a server, a storage system controller, a storage node controller, or the like. As shown in FIG. 1A, the apparatus 10 may include a processor 101 that may control operations of the apparatus 10. As shown in FIG. 1B, the snapshot object controller 100 may include a processor 102 that may control operations of the snapshot object controller 100. As shown in FIG. 2, the volume manager 202 may include a volume processor 204 that may control operations of the volume manager 202. The processors 101 and 102 and volume processor 204 may each be a semiconductor-based microprocessor, a central processing unit (CPU), an application specific integrated circuit (ASIC), a field-programmable gate array (FPGA), and/or other suitable hardware device. Although the apparatus 10 and snapshot object controller 100 have each been depicted as including a single processor 101, 102 and the volume manager 202 has been depicted as including a single volume processor 204, it should be understood that the apparatus 10, the snapshot object controller 100, and the volume manager 202 may each include multiple processors, multiple cores, or the like, without departing from the scopes of the apparatus 10, the snapshot object controller 100, or the volume manager 202 disclosed herein.

The apparatus 10 may include a machine-readable storage medium 109 that may have stored thereon machine-readable instructions 111 (which may also be termed computer readable instructions) that the processor 101 may execute. The snapshot object controller 100 may include a machine-readable storage medium 110 that may have stored thereon machine-readable instructions 112-120 (which may also be termed computer readable instructions) that the processor 102 may execute. The machine-readable storage medium 109, 110 and the volume machine-readable storage medium 210 may each be an electronic, magnetic, optical, or other physical storage device that includes or stores executable instructions. The machine-readable storage medium 109, 110 and the volume machine-readable storage medium 210 may each be, for example, Random Access memory (RAM), an Electrically Erasable Programmable Read-Only Memory (EEPROM), a storage device, an optical disc, and the like. The machine-readable storage medium 109, 110 may be a non-transitory machine-readable storage medium, where the term “non-transitory” does not encompass transitory propagating signals.

The target volume 210 may include a plurality of storage nodes 212-1 to 212-M, where the variable “M” is a value greater than one. The volume manager 202 and the storage nodes 212-1 to 212-M may be communicatively coupled to one another via a network, such as a local area network, a fiber channel network, the Internet, or the like. In addition or alternatively, the storage nodes 212-1 to 212-M may be housed in a common electronics rack, across multiple electronics racks, in a common data center, across multiple data centers, or the like.

According to examples, the snapshot object controller 100 may receive instructions from and may send data to a host 220 via a network 230. The host 220 may be a computing device through which input/output (IO) instructions, snapshot creation instructions, or the like, may be communicated to the snapshot object controller 100. In one regard, the host 220 may include a management entity 222, e.g., a group/cluster level management daemon, that may, for instance, send snapshot requests to the snapshot object controller 100 as discussed in greater detail herein. The snapshot object controller 100 may also communicate responses and acknowledgement messages to the host 220. In any regard, the network 230 may be a local area network, a fiber channel network, the Internet, or the like. In other examples, the management entity 222 may instead be executed in the target volume 210 or in another volume.

The volume processor 204 may fetch, decode, and execute instructions to generate snapshots in a target volume snapshot format 214, which may be a conventional snapshot format. For example, the volume processor 204 may generate a Redirect-On-Write (“ROW') snapshot. Other types of snapshots such as a Copy-On-Write (”COW') snapshot may be used as well. Whichever type of target volume snapshot is used, the volume processor 204 may maintain local snapshots for the target volume 210. In various examples, the snapshot object controller 100 may parse the target volume snapshot to generate full snapshots, delta snapshots, and/or synthetic snapshots in the object-based snapshot format 230 for copying to the object-based storage system 240. In some examples, the snapshot object controller 100 may generate the target volume snapshots. In this regard, the snapshot object controller 100 may perform the operation of volume manager 202 to generate snapshots in the target volume snapshot format 214.

According to examples, the object-based storage system 240 may be within the same network local to the target volume 210. In some examples, the object-based storage system 240 may be remote from the target volume 210. In some of these examples, the object-based storage system 240 may be a cloud-based storage system (or solution) operated by a Cloud Service Provider (“CSP”). The object-based storage system 240 in this regard may execute an object-based storage agent 242, which may execute various I/O operations to create, access, and delete snapshots at the object-based storage system 240. In this regard, the snapshot object controller 100 may interface with the object-based storage agent 242 via network 230 to create, access, and delete snapshots stored in the object-based snapshot format 230 at object-based storage 244. In various examples, the object-based storage agent 242 may be executed to perform garbage collection operations on snapshots stored at the object-based storage 244. In various examples, the CSP may charge a fee for I/O operations such as writing data and receiving data (egress from the object-based storage system 240). These operations may not only be costly from a computational perspective but may also require payment of fees to do so. The snapshot object controller 100 and the object-based snapshot format 230 may, in examples, operate to minimize these computational and other costs.

Attention will now turn to operations at processor 101, 102 to generate snapshots for copying to the object-based storage system 240 (for storage at and access and deletion from object-based storage 244). Referring to FIG. 1A, the processor 101 may fetch, decode, and execute the instructions 111 to store copies of the volume object, snapshot object, data bucket object, and data blocks to the object-based data system 240. The volume object may point to each of the snapshot objects that each correspond to a snapshot created for the volume. In addition, each of the snapshot objects may have a list of one or more of the data bucket objects for the corresponding snapshot, in which, for incremental snapshots, the corresponding snapshot object may point to identifications of data bucket objects that represent changes made to the data in the volume since a prior snapshot. Moreover, each data bucket object may have a list of one or more data blocks including data representing the snapshot corresponding to the snapshot object pointing to the data bucket object.

Referring to FIG. 1B, the processor 102 may fetch, decode, and execute the instructions 112 to receive a snapshot creation request for a volume of data represented by a volume object.

The processor 102 may fetch, decode, and execute the instructions 114 to generate or update a volume object with a link to a snapshot object for the snapshot.

The processor 102 may fetch, decode, and execute the instructions 116 to generate the snapshot object with a link to one or more data bucket objects.

The processor 102 may fetch, decode, and execute the instructions 118 to generate the one or more data bucket objects each having a list of one or more data blocks including data representing the target volume 210. For full snapshots, the data representing the target volume 210 may include actual data blocks. For delta snapshots, the data representing the target volume 210 may include only difference data from a prior snapshot. For synthetic snapshots, the data representing the target volume 210 may include data blocks that have changed since a prior snapshot.

The processor 102 may fetch, decode, and execute the instructions 120 to store copies of the volume object, snapshot object, data bucket object, and data blocks to the object-based data system 240.

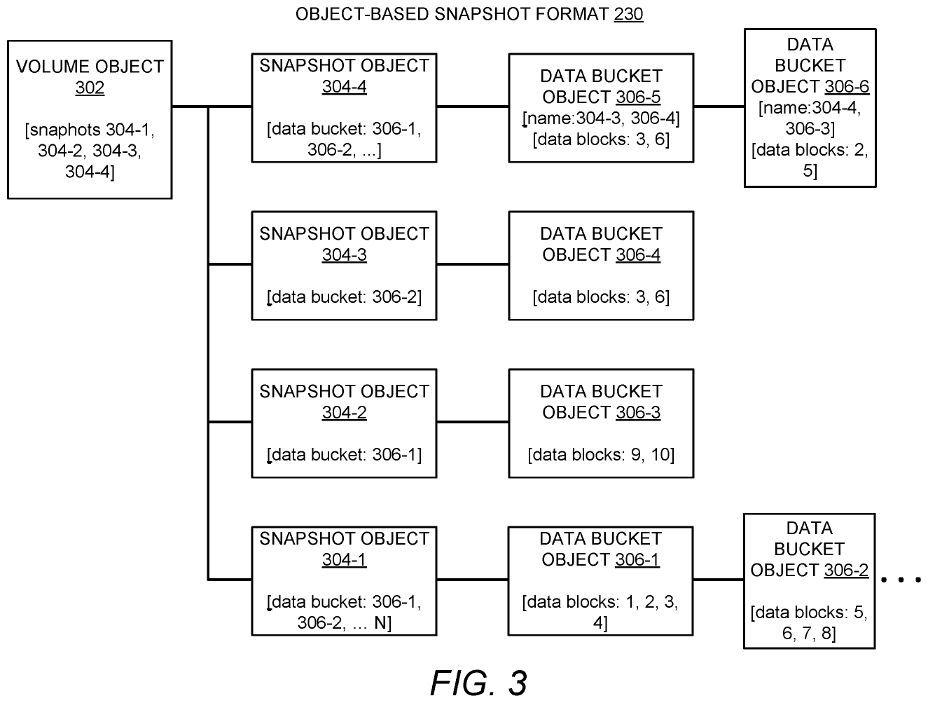

FIG. 3 shows a block diagram of an example object-based snapshot format 230 for storing full and incremental snapshots of a storage volume in an object-based storage system 240. In examples, the object-based snapshot format 230 may be self-describing so that the associated snapshots may be restored from the object-based storage system 240 onto various types of storage volumes. In this manner, the snapshots described herein may not be dependent on the particular type of storage system to which snapshots are restored or from which the snapshots are generated. It should be noted that the particular number of objects shown in FIG. 3 are for illustrative purposes. For example, the ellipses (“. . . ”) for snapshot object 304-4 indicates that other N data buckets may be included in this snapshot.

A volume object 302 may represent a volume and may include volume properties (shown in Table 1 below) and a list of snapshot objects that have been generated for the corresponding volume. The volume object 302 may be re-written with each backup (each time a new snapshot is generated). As such, the size of the volume object 302 may be proportional to the number of snapshots that are generated.

Table 1 represents a more detailed listing of examples of data stored at volume object 302 for illustration purposes.

TABLE 1

| | | | | | |
|---|---|---|---|---|---|
| Volume | Volume | Volume | Block | Data | Compression |
| Object | name | Size | Size | bucket | type |
| Identifier | | | | object size | |

Vector of snapshot index objects, searchable list of Virtual Machines (“VMs”) whose data is backed up, and/or other data used by a storage node.

A snapshot object 304 (illustrated as snapshot objects 304-1 . . . 4 and shown in more detail at Table 2 below) may include metadata information of the snapshot and index information of all the data written in this snapshot. Each snapshot object 304 may include pointers to data bucket objects 306 that pertain to the snapshot. In some examples, a snapshot object 304 may include parent or predecessor snapshot data for all shared data this snapshot inherited from its predecessor snapshot. Thus, a snapshot may share data bucket objects with other snapshots—metadata from the snapshot object 304 may be used to identify prior snapshots from which shared data may be inherited. This may facilitate efficient I/O operations on the snapshot, including access, deletes, and garbage collection.

A snapshot object 304 may include different types of indexes to point to data objects. In one type of index, an index may point to a data bucket object, which may represent a contiguous set of data blocks from the target volume 210. These types of indexes may be used for long retention snapshots

In another type of index, each index may point to a data block from the target volume 210. This type of indexing is computationally expensive when restoring a snapshot. As such, these types of indexes may be used for delta snapshots and may not be preferable for long retention snapshots. The indexes described herein may include a bloom filter of indexes that allows efficient searching of the indexed data, which would otherwise be computationally expensive as previously noted. For instance, the bloom filter may be used to efficiently determine whether or not certain data exists in a snapshot. As such, snapshots may be efficiently searched for various I/O operations described herein.

Table 2 represents a more detailed listing of examples of data stored at snapshot object 304 for illustration purposes.

TABLE 2

| | | | | | | | |
|---|---|---|---|---|---|---|---|
| Snapshot | Parent | Snapshot | Volume | Volume | Block | Data | Snapshot |
| Object | Snapshot | Name | Object | Size | Size | Bucket | Index |
| Identifier | Object | | ldentifier | | | Size | Type |
| | Identifier | | | | | | (Full, |
| | | | | | | | Delta, |
| | | | | | | | Synthetic) |

Data Bucket Indexes List of Data Bucket Objects used by this snapshot (Data Block Object identifier, Data Bucket Object identifier, Bucket offset, Block Length, Searchable list of VMs

A data bucket object 306 (illustrated in FIG. 3 as data bucket objects 306-1 to 306-6) may each include pointers to one or more data blocks 1-10. Other data blocks may be used as well. A data bucket object 306 may include a listing of one or more data blocks in common with another data bucket object. As such, like data bucket object sharing and inheritance with snapshots, data blocks may be shared/inherited in some examples as well, enhancing efficiency of block storage device usage and I/O operations. In some examples, each of the objects may be assigned with an identification such a name. For clarity, only data bucket objects 306-5 and 306-6 are illustrated with a name. In some instances, the name may denote the data contained therein. For example, a data bucket object 306 may include an indication of the first snapshot for which the data bucket was introduced into a snapshot and stored in the system. As shown in FIG. 3, for example, data object bucket 306-5 includes a name “304-3, 306-4” that indicates that this data bucket object was first introduced by snapshot object 304-3 as data buck object 306-4. A given data bucket may be overwritten. Such overwrites may be versioned based on updating the name to indicate such versioning. For instance, as shown in FIG. 3, data bucket object 306-6 may be assigned with a name “304-4, 306-3” to indicate that the original data bucket object 306-3 has been overwritten and that this data bucket object is different relative to the changed data bucket object 306-3. In particular, the “304-4” portion of the name indicates that this data bucket object is not the same as the data bucket object 306-3 from the original snapshot object 304-2 that introduced this data bucket object into the system.

Table 3 represents a more detailed listing of examples of data stored at data bucket object 306 for illustration purposes. Each data block 1-8 listed in a data bucket object 306 may include header information that describes the block. Such information may include a block offset of where to find the block in the target volume 210, the start offset of the block in the bucket (where to find the block in the data object bucket 306), length of the block, and/or other information.

TABLE 3

| | | | |
|---|---|---|---|
| | Origin/Creation | | |
| Data Bucket Object | Snapshot Object | Bucket | Compression |
| identifier | identifier | length | type |

Individual Block Headers (target volume block offset, start offset of the block in the
bucket, block length)

| | | | |
|---|---|---|---|
| Block 1 data | Block 2 data | . . . | Block N data |

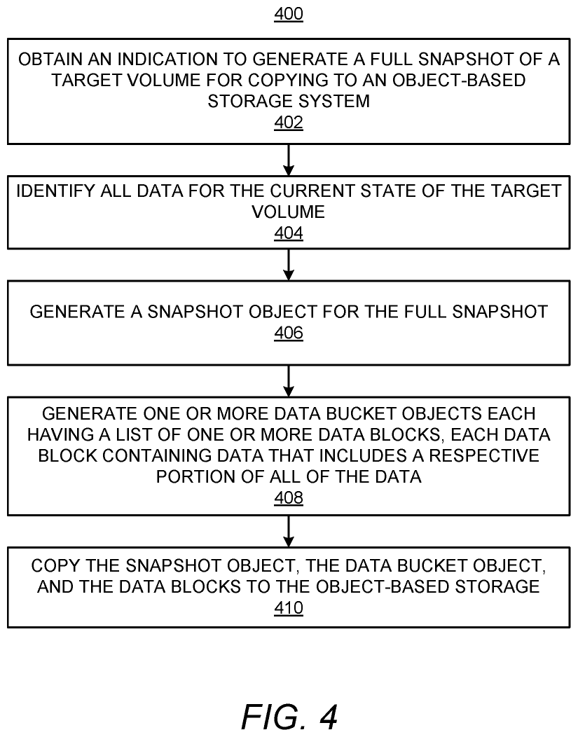

Various manners in which the snapshot object controller 100 may operate to generate and use the object-based snapshot format 230 are discussed in greater detail with respect to the methods 400, 500, 600, and 700 respectively depicted in FIGS. 4, 5, 6, and 7. It should be understood that the methods 400, 500, 600, and 700 may include additional operations and that some of the operations described therein may be removed and/or modified without departing from the scopes of the methods 400, 500, 600, and 700. The descriptions of the methods 400, 500, 600, and 700 are made with reference to the features depicted in FIGS. 1-3 for purposes of illustration.

As previously noted, various types of snapshots may be generated. Examples include full snapshots, delta snapshots, and synthetic snapshots. Each type of snapshot may be generated at different times to optimize storage, access, and garbage collection operations on the data for which snapshots are generated.

Reference will be made first to FIG. 4, which illustrates an example method of generating a full snapshot. As shown in FIG. 4, at block 402, the processor 102 may obtain an indication to generate a full snapshot of the target volume 210 for copying to the object-based storage system 240. For instance, the host 220 may receive a request from a user to generate a full snapshot. The host 220 may then forward the request to the processor 102. In some examples, the indication may be based on a schedule of full backups to be made. In these instances, the indication may be triggered by a daemon or other background process that automatically generates the indication based on the schedule.

At block 404, the processor 102 may identify all data for the current state of the target volume 210. For instance, the processor 102 may obtain metadata indexes from the target volume snapshot format 214 for the current state of the target volume 210. These metadata indexes may have been generated by the volume manager 202. Different types of target volumes may indicate their current states in different ways. The processor 102 may be configured to understand the ways in which different target volumes store their current states (and respective snapshot data and block storage). For instance, the processor 102 may access an Application Programming Interface (“API”) to interface with the various types of target volumes. At block 406, the processor 102 may generate a snapshot object for the full snapshot. The snapshot object may include pointers to data bucket objects generated at block 408.

At block 408, the processor 102 may generate one or more data bucket objects. Each data bucket object may include a list of one or more data blocks. Each data block in turn may include data that includes a respective portion of all of the data from the current state of the target volume. In some instances, the data blocks listed in the data bucket objects are laid out in a manner similar to the target volume. For instance, the target volume may use 4 kilobyte (4K) blocks and the data blocks listed in each data bucket object may be similarly configured. In examples, the data for full snapshots may be logically laid out in continuous data blocks in certain chunks of data, such as 1 megabyte (1 MB) logical offset range of the volume. Other block sizes may be used as well. At block 410, the processor 102 may copy the snapshot object, the data bucket objects, and the data blocks to the object-based storage system 240.

Recovery of a full snapshot may include obtaining the metadata corresponding to the full snapshot, identifying the data bucket objects and respective data blocks, and copying the data blocks from the object-based storage for restoration on the target volume (or other volume of data). Because the metadata of the snapshot is self-describing, the layout of the data blocks may be discerned and the data may be restored regardless of the type of volume or storage to which the data is restored or from which the data was obtained.

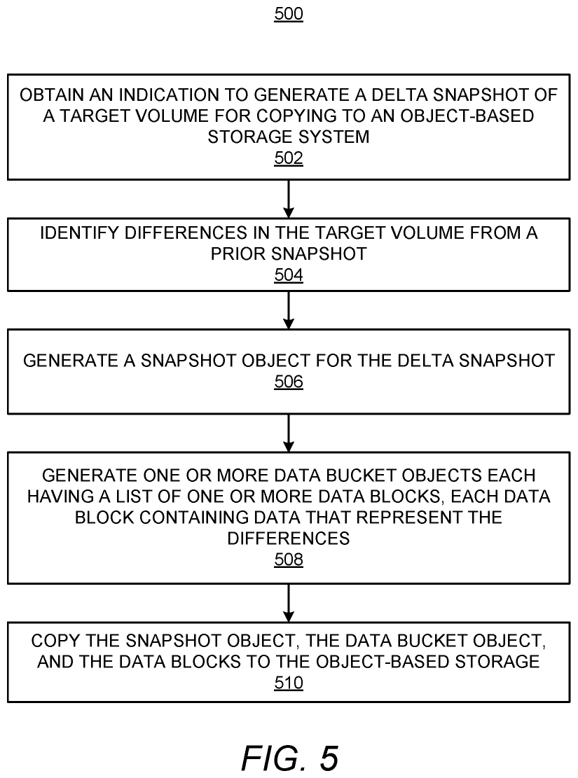

With reference to FIG. 5, at block 502, the processor 102 may obtain an indication to generate a delta snapshot of the target volume 210 for copying to the object-based storage system 240. For instance, the management entity 222 may process a schedule of predefined times (such as daily, weekly, and so forth) at which to generate a delta snapshot. The processor 102 may accordingly generate and copy snapshots to the object-based storage system 240 according to the schedule, as dictated by the management entity 222. In some instances, the indication may be an on-demand request to generate a delta snapshot from a user such as a system administrator.

At block 504, the processor 102 may identify differences in the current state of the target volume 240 with a prior snapshot. The prior snapshot can be, for instance, another delta snapshot, a full snapshot, or a synthetic snapshot. In some examples, the differences may be identified based on changes made to the data in the current target volume 210 relative to the last prior snapshot. These changes may be identified based on a difference function, comparison of the data blocks that underly the current state of the target volume 240 and the data blocks of the latest prior snapshot, and/or other techniques.

At block 506, the processor 102 may generate a snapshot object for the delta snapshot (also referred to as a “delta snapshot object”). The delta snapshot object may include pointers to data bucket objects generated at block 508. In some instances, the delta snapshot object may identify the latest prior snapshot. In this manner, the latest prior snapshot may be used to restore the delta snapshot corresponding to the delta snapshot object.

At block 508, the processor 102 may generate one or more data bucket objects for the delta snapshots (also referred to as “delta snapshot data bucket objects”). Like a data bucket object for full snapshots, each delta snapshot data bucket object may include a list of one or more data blocks. However, unlike a data bucket object for full snapshots, each data block for delta snapshots may include data representing only the differences identified at block 504. Also unlike data blocks for a full snapshot, data blocks listed in a given data bucket object for delta snapshots may, in examples, be discontinuous. This is because delta snapshots may represent only differences made to a volume of data and overwrites on a volume of data are often made randomly.

At block 510, the processor 102 may copy the snapshot object, the data bucket objects, and the data blocks to the object-based storage system 240.

Recovery of a delta snapshot may include obtaining the metadata corresponding to the delta snapshot, identifying the data bucket objects and respective data blocks, and obtaining the differences from the delta snapshot and a prior snapshot. Delta snapshots may represent only these differences. As a result, the latest full or synthetic snapshot is required to restore the data corresponding to the state of the target volume represented by a delta snapshot. For example, the data corresponding to the state of the target volume for the latest full or synthetic snapshot may be obtained (or otherwise restored) and the delta snapshot is applied to that data. In particular examples, the data blocks may include deltas (data or files that represent changes in data). These deltas may identify a block of data and how that data was changed. In this manner, a state of the data as it existed when a delta snapshot was created may be recovered based on the full copy of the data from the latest full or synthetic snapshot. In examples, any intervening delta snapshots from the current delta snapshot to the latest full or synthetic snapshot are respectively resolved in order to obtain the data corresponding to the delta snapshot. For example, to recover a delta snapshot (delta snapshot number 3) where there exist two previous delta snapshots (delta snapshot numbers 1 and 2) prior to a latest full or synthetic snapshot, the system may restore the latest full or synthetic snapshot, then restore the delta snapshot 1 by applying the differences from the delta snapshot 1 to the latest full or synthetic snapshot. The delta snapshot 2 may be restored by applying the differences from the delta snapshot 2 to the recovered delta snapshot 1. The delta snapshot 3 may be restored by applying the differences from the delta snapshot 3 to the recovered delta snapshot 2. Other numbers of intervening delta snapshots may be resolved and recovered accordingly.

In some examples, a delta snapshot may be restored on-demand. For instance, the processor 102 may receive a snapshot identifier that identifies a snapshot to be recovered (also referred to as the “requested snapshot”). The snapshot identifier may be received from a user that wishes to recover the requested snapshot. The processor 102 may identify the latest full or synthetic snapshot prior to the snapshot to be recovered and any intervening snapshots. The processor 102 may obtain the data from the latest full or synthetic snapshot and apply the differences from each of any intervening snapshots and the requested snapshot to the latest full or synthetic snapshot. In examples in which a cloud-based storage system from a CSP is used to store snapshots, the processor 102 may invoke the object-based storage agent 242 to load the latest full or synthetic snapshot and apply the differences. In these examples, the processor 102 may trigger the object-based storage agent 242 with the snapshot identifiers for the latest full or synthetic snapshot, any intervening snapshots, and the requested snapshot. The processor 102 may also provide the object-based storage agent 242 with the offset and length of the relevant blocks of data so that the object-based storage agent 242 may properly step through the data to be recovered. In some examples, to improve performance, the processor 102 or the object-based storage agent 242 may perform a filtering operation based on indexed data in the snapshots. For instance, the processor 102 or the object-based storage agent 242 may use a bloom filter of indexes to determine whether or not data is in a given snapshot. If not, then that snapshot may be ignored, improving the efficiency by which snapshots are processed during recovery.

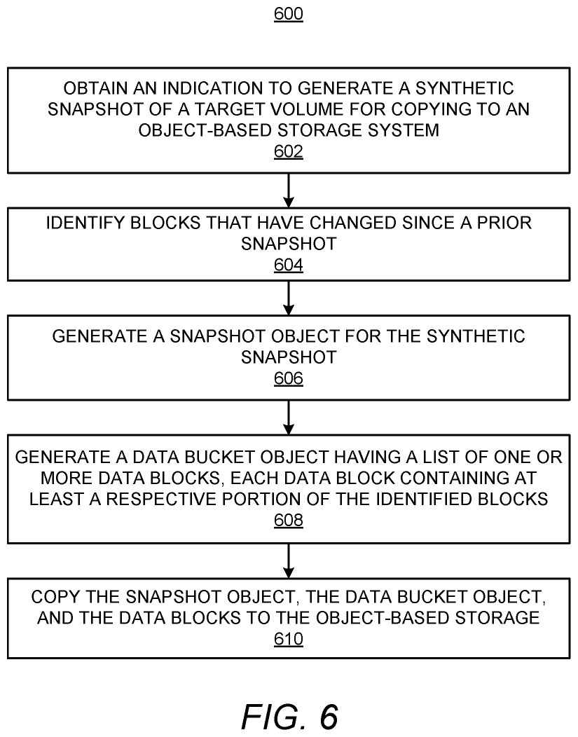

With reference to FIG. 6, at block 602, the processor 102 may obtain an indication to generate a synthetic snapshot of the target volume 210 for copying to the object-based storage system 240. In various examples, the indication may be based on monitoring parameters at the target volume 210. Such monitoring may be performed by the processor 102 and/or volume processor 204. The monitored parameters may include, for example, a change rate, a number of snapshots created over a given time period, and/or other parameters that can trigger creation of a synthetic snapshot.

In other examples, the host 220 may receive a request from a user to generate a synthetic snapshot. The host 220 may then forward the request to the processor 102. In yet other examples, the indication may be based on a schedule of synthetic backups to be made. In these instances, the indication may be triggered by a daemon or other background process that automatically generates the indication based on the schedule.

At block 604, the processor 102 may identify blocks that have changed since a prior snapshot, such as a synthetic or full snapshot. Even if a small portion of a data chunk has changed, the entire chunk may be stored again in a data bucket object. For instance, even if a 1 KB portion of a 1 MB chunk has changed, the current version of the entire chunk will be stored as a change in the synthetic snapshot (though compressed, in some examples). Changes may be detected based on examining the metadata or other snapshot information of the target volume 240 and/or by comparing the current data in the target volume since the latest synthetic snapshot or latest full snapshot.

At block 606, the processor 102 may generate a snapshot object for the synthetic snapshot (also referred to as a “synthetic snapshot object”). The synthetic snapshot object may include pointers to data bucket objects generated at block 608.

At block 608, the processor 102 may generate one or more data bucket objects for the synthetic snapshots (also referred to as “synthetic snapshot data bucket objects”). Like a data bucket object for delta snapshots, each synthetic snapshot data bucket object may include a list of one or more data blocks. However, unlike a data bucket object for delta snapshots, each synthetic snapshot data bucket object includes all blocks for a given chunk when one or more of the data blocks have changed since a prior snapshot, as identified at block 604. Also unlike data blocks for delta snapshots, data blocks for synthetic snapshots may be laid out continuously in a manner similar to data blocks for a full snapshot.

At block 610, the processor 102 may copy the snapshot object, the data bucket objects, and the data blocks to the object-based storage system 240.

Recovery of a synthetic snapshot does not require restoration of a prior synthetic or full snapshot. This is because, unlike delta snapshots that store only differences that from a prior snapshot, synthetic snapshots include the actual data that has changed. Rather, recovery may, for instance, involve identifying the changed data block using, for example, the synthetic snapshot metadata and replacing the changed data with the corresponding data block from the synthetic snapshot.

Referring to FIGS. 4-6, in some examples, creating data bucket objects may employ fingerprinting of data chunks to further enhance space efficiency. In these examples, prior to creating a data bucket object, the processor 102 may perform a tag search of a data chunk to be stored. For example, the processor 102 may generate a fingerprint of the data chunk. The fingerprint may be generated using a hashing technique that generates a unique hash for a given set of data. Other types of fingerprinting techniques may be used as well or in the alternative, so long as the same technique is used each time a data chunk is to be added. Each data bucket object may be tagged with the fingerprint of a data chunk listed therein with a refcount (a counter) as its value. To perform the tag search, the processor 102 may compare the fingerprint of the data chunk to be stored with fingerprints of data chunks already stored in connection with prior snapshots. If a match is found (indicating that the data chunk to be added has already been stored in connection with another snapshot), then the refcount for that fingerprint may be incremented. The snapshot index may be updated with the fingerprint (the key of the tagged index) so as to point to the existing data chunk. This tagging and tag searching process may provide space savings for target volumes (and/or their clones) by reducing storage of redundant data. If a match is not found, then the data chunk may be written to the object-based storage.

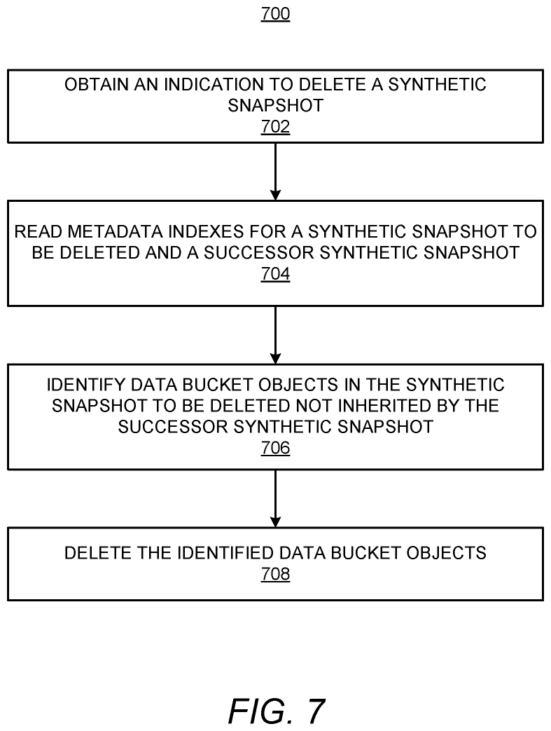

Once snapshots are created, deletion of prior snapshots may be made for garbage collection purposes. Full and delta snapshots may be deleted efficiently by, for example, simply deleting data bucket objects and corresponding blocks. For delta snapshots, processor 102 may permit such deletion only if certain conditions are met, such as only when a previous and/or successor snapshot is available. The previous and/or successor snapshot may be required to be a full or synthetic snapshot to ensure recoverability upon deletion. Other checks may be made before deleting snapshot-related data, as will be discussed with reference to FIG. 7.

As previously noted, a snapshot in the object-based storage system may inherit data bucket objects and/or data blocks from another snapshot. As such, when deleting synthetic snapshots, the garbage collection operations may first ensure that such inheritance is taken into account for garbage collection operations. It should be noted that the method 700 may be executed by the object-based storage agent 242 operating on the object-based storage system 240. For examples in which the object-based storage system 240 is a cloud-based system operated by a CSP, the object-based storage agent 242 may perform the garbage collection/synthetic snapshot deletion illustrated in FIG. 7. As such, egress from the object-based storage system 240 to examine data to be deleted is unnecessary and saves not only compute I/O but also any egress fees charged by the CSP.

Turning now to FIG. 7, at block 702, the processor 102 may obtain an indication to delete a synthetic snapshot. The indication may be based on a retention schedule that specifies a length of time in which to retain snapshots. The retention schedule may specify such retention for each type of snapshot (full, delta, or synthetic), or may specify retention for all types of snapshots. In other examples, the indication may be based on a request from the management entity 222 made through the host 220.

At block 704, the processor 102 may obtain metadata indexes for a synthetic snapshot to be deleted and metadata indexes for a successor synthetic snapshot. Because only the metadata is obtained, and not the actual underlying data block data, read I/O and egress costs for such underlying data may be avoided.

At block 706, the processor 102 may identify one or more data bucket objects in the synthetic snapshot to be deleted that are not inherited by the successor synthetic snapshot.

At block 708, the processor 102 may delete the non-inherited data bucket objects. In this manner, any inherited data blocks may be retained while other ones of the data bucket objects may be deleted.

Some or all of the operations set forth in the methods 400, 500, 600, and 700 may be included as utilities, programs, or subprograms, in any desired computer accessible medium. In addition, the methods 400, 500, 600, and 700 may be embodied by computer programs, which may exist in a variety of forms. For example, some operations of the 400, 500, 600, and 700 may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

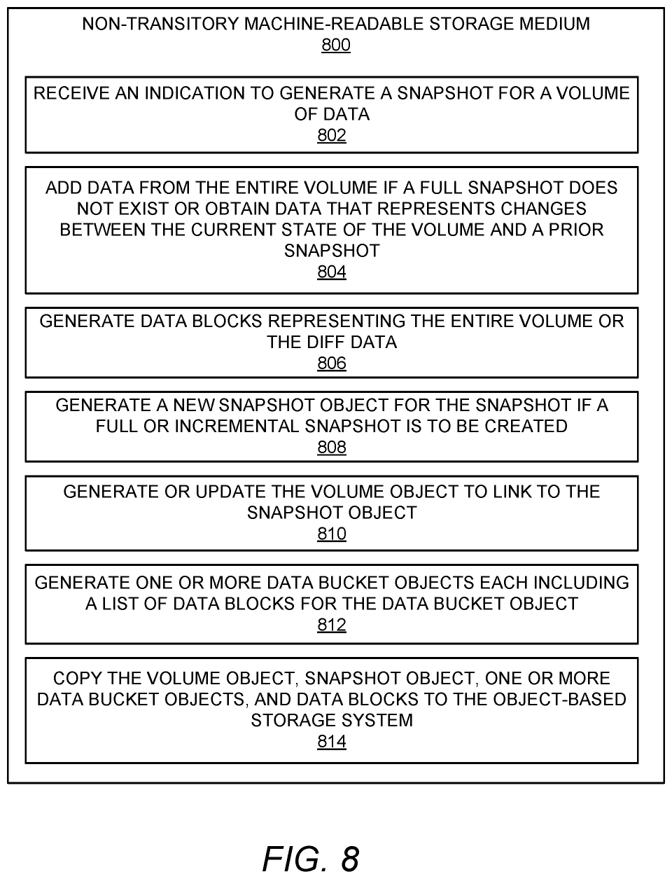

With reference now to FIG. 8, there is shown a block diagram of an example non-transitory machine-readable storage medium 800 for generating snapshots for copying to an object-based storage system. The machine-readable storage medium 600 may be an electronic, magnetic, optical, or other physical storage device that includes or stores executable instructions. The machine-readable storage medium 600 may be, for example, Random Access memory (RAM), an Electrically Erasable Programmable Read-Only Memory (EEPROM), a storage device, an optical disc, and the like.

The non-transitory machine-readable storage medium 800 may have stored thereon machine-readable instructions 802-814 that a processor, such as the processor 102, may execute.

The machine-readable instructions 802 may cause the processor to receive an indication to generate a snapshot for the target volume 210.

The machine-readable instructions 804 may cause the processor to add data from the entire target volume 210 if a full snapshot does not exist (and has been requested) or obtain data that represents changes between the current state of the target volume and a prior snapshot, such as the most current prior snapshot. The data that represents changes may be delta or difference data that represents changes made (for delta snapshots) or may be actual changed data (for synthetic snapshots).

The machine-readable instructions 806 may cause the processor to generate one or more data blocks representing the entire target volume (for full snapshots) or the data representing the changes (for incremental snapshots such as delta and synthetic snapshots).

The machine-readable instructions 808 may cause the processor to generate a new snapshot object for the snapshot if a full or incremental snapshot is to be created. It should be noted that if an incremental snapshot is to be created, but no changes have been made to the target volume since the latest snapshot, then snapshot creation may terminate.

The machine-readable instructions 810 may cause the processor to generate or update the volume object to include a link to the snapshot object. A given volume object may include links to multiple snapshot objects.

The machine-readable instructions 812 may cause the processor to generate one or more data bucket objects. Each data bucket object may include a list of data blocks for the data bucket object.

The machine-readable instructions 814 may cause the processor to copy the volume object, snapshot object, one or more data bucket objects, and the data blocks to the object-based storage system 240.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. For example, although described in the context of object-based storage and in particular to cloud-based storage solutions from a CSP, the examples discussed throughout may be applied to other storage solutions so long as a self-describing format is used and data may be modeled based on the disclosure herein. It is also noted that all or a portion of the functions of the processor 101, 102 may operate on one or more of the components of system 200. For instance, apparatus 10 and the snapshot object controller 100 may each operate on the target volume 210, as part of the volume manager 202, and/or the object-based storage system 240.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
store copies of full and incremental snapshots of a volume to an object-based storage system in a format comprising:
a volume object, a plurality of snapshot objects, and a plurality of data bucket objects;
the volume object pointing to each of the snapshot objects that each correspond to a snapshot created for the volume,
each of the snapshot objects having a list of one or more of the data bucket objects for the corresponding snapshot, wherein, for incremental snapshots, the corresponding snapshot object points to identifications of data bucket objects that represent changes made to the data in the volume since a prior snapshot, and
each data bucket object having a list of one or more data blocks including data representing the snapshot corresponding to the snapshot object pointing to the data bucket object.

2. The apparatus of claim 1, wherein each snapshot object is one of a full snapshot object, a delta snapshot object, and a synthetic snapshot object, and wherein the instructions are further to cause the processor to:
generate the delta snapshot object or the synthetic snapshot object, the delta snapshot object, when generated, pointing to one or more data bucket objects that represent changes since a prior snapshot of the volume based on differences of data on the volume made since a prior snapshot, and the synthetic snapshot object, when generated, pointing to one or more data bucket objects that have pointers to respective identifications of one or more data blocks that each store data that have changed since a prior snapshot of the volume.

3. The apparatus of claim 2, wherein the instructions are further to cause the processor to:
based on a predefined schedule, identify a difference between a current state of the volume with a latest prior snapshot of the volume;
generate difference data that represents only the difference; and
generate the delta snapshot object based on the difference data.

4. The apparatus of claim 3, wherein the difference data is stored over a set of discontinuous data blocks.

5. The apparatus of claim 3, wherein the instructions are further to cause the processor to:
identify a delta snapshot to be deleted;
identify a delta snapshot object corresponding to the identified delta snapshot based on metadata that describes the identified delta snapshot; and
delete all of the data blocks corresponding to the identified delta snapshot object.

6. The apparatus of claim 5, wherein to identify the delta snapshot to be deleted, the instructions are further to cause the processor to:
determine that a full or synthetic snapshot has been generated after the delta snapshot to be deleted was generated; and
target the delta snapshot for deletion responsive to the determination.

7. The apparatus of claim 3, wherein the instructions are further to cause the processor to:
receive an indication to restore a delta snapshot corresponding to the delta snapshot object;
obtain the latest prior full or synthetic snapshot of the volume;
obtain other difference data for each of any intervening delta snapshots that were generated after the latest prior full or synthetic snapshot and before the delta snapshot;
obtain one or more data blocks inherited from another snapshot;
apply the other difference data from the intervening delta snapshots, if any, in the order in which they were created after the latest prior full or synthetic snapshot to generate respective restorations of an intervening delta snapshot, and apply the difference data of the delta snapshot object to: (i) a latest one of the restored intervening delta snapshots, if any, and the one or more data blocks inherited from the other snapshot, or (ii) the latest prior full or synthetic snapshot of the volume and the one or more data blocks inherited from the other snapshot if no intervening delta snapshots exist.

8. The apparatus of claim 2, wherein the instructions are further to cause the processor to:
detect a triggering event to generate a synthetic snapshot;
in response to the triggering event, identify one or more blocks of changes since a latest prior snapshot of the volume;
copy the one more data blocks that have changed;
store the copied one or more data blocks as a set of continuous data blocks; and
generate one or more synthetic snapshot data object buckets that point to the set of continuous data blocks.

9. The apparatus of claim 8, wherein to detect the triggering event, the instructions are further to cause the processor to:
obtain an overwrite rate at the object-based storage system or a number of delta snapshots created since a prior synthetic or full snapshot; and
determine that the overwrite rate has exceeded a predefined overwrite threshold rate or that the number of delta snapshots has exceeded a predefined delta count threshold.

10. The apparatus of claim 8, wherein the instructions are further to cause the processor to:
receive an indication to restore the synthetic snapshot;
identify the one or more synthetic snapshot data bucket objects that point to the set of continuous data blocks; and
replace data blocks from the latest prior snapshot with corresponding ones of the set of continuous data blocks.

11. The apparatus of claim 8, wherein the instructions are further to cause the processor to:
receive an indication to delete a prior synthetic snapshot from which the synthetic snapshot inherits at least one data block;
obtain, for a garbage collection process initiated in response to the indication to delete the prior synthetic snapshot, metadata from the prior synthetic snapshot;
compare the metadata from the prior synthetic snapshot with metadata from the synthetic snapshot;
identify data blocks not inherited from the prior synthetic snapshot based on the comparison; and
delete the identified data blocks.

12. The apparatus of claim 1, wherein the instructions are further to cause the processor to:
generate a catalog of the full or incremental snapshots of the volume stored at the object-based storage system, the catalog including metadata from the full or incremental snapshots;
receive a request to access information describing the full or incremental snapshots; and
responsive to the request, provide a listing of the full or incremental snapshots, including a description of the data relating to the full or incremental snapshots based on the catalog.

13. The apparatus of claim 12, wherein the metadata comprises application specific metadata including a Virtual Machine (“VM”) name or a database name to which the full or incremental snapshots relate and the request includes a search parameter including the VM name or the database name, and wherein the instructions are further to cause the processor to:
search the catalog based on the search parameter, wherein the listing of the full or incremental listing is found based on the search parameter.

14. The apparatus of claim 1, wherein the instructions are further to cause the processor to:
store indexed pointers each from the snapshot object to a corresponding data bucket object;
receive a request to read, access, or delete data from a specified snapshot; and
access the indexed pointers to search for corresponding data bucket objects based on a filtering function.

15. A method comprising:
obtaining, by a processor, an indication to generate an incremental snapshot of a volume to be copied to an object-based storage system;
identifying, by the processor, changes made to data in the volume since a prior snapshot;
generating, by the processor, a snapshot object for the incremental snapshot, the snapshot object comprising a list of one or more data bucket objects that point to one or more data blocks that include data representing the incremental snapshot, one or more indexes for indexing the one or more data blocks, and, for a delta incremental snapshot, information identifying at least one other snapshot object from which the snapshot object inherits at least one data block;
generating, by the processor, a data bucket object having a list of one or more data blocks, each data block including data that represents the changes made to the data in the volume since the prior snapshot; and
copying, by the processor, the snapshot object, the data bucket object, and the one or more data blocks to the object-based storage.

16. The method of claim 15, wherein generating a snapshot object for the incremental snapshot comprises:
generating (i) a delta snapshot object pointing to one or more data bucket objects that represent changes since a prior snapshot of the volume based on differences of data on the volume made since a prior snapshot and not the changed data itself, or (ii) a synthetic snapshot object that points to one or more data bucket objects that include respective identifications of one or more blocks that each store data that have changed since a prior snapshot of the volume.

17. The method of claim 16, further comprising:
detecting, by the processor, a triggering event to generate a synthetic snapshot;
in response to the triggering event, identifying, by the processor, one or more blocks of changes since a latest prior snapshot of the volume;
copying, by the processor, the one more data blocks that have changed;
storing, by the processor, the copied one or more data blocks as a set of continuous data blocks; and
generating, by the processor, one or more synthetic snapshot data object buckets that point to the set of continuous data blocks.

18. The method of claim 17, further comprising:
receiving an indication to delete a prior synthetic snapshot from which the synthetic snapshot inherits at least one data block;
obtaining, for a garbage collection process initiated in response to the indication to delete the prior synthetic snapshot, metadata from the prior synthetic snapshot;
comparing the metadata from the prior synthetic snapshot with metadata from the synthetic snapshot;
identifying data blocks not inherited from the prior synthetic snapshot based on the comparison; and
deleting the identified data blocks.

19. The method of claim 15, wherein copying the snapshot object, the data bucket object, and the one or more data blocks to the object-based storage comprises:
uploading snapshot object, the data bucket object, and the one or more data blocks to a cloud-based storage system.

20. A non-transitory computer readable medium on which is stored machine readable instructions that when executed by a processor, cause the processor to:
store copies of full and incremental snapshots of a volume to an object-based storage system in a format comprising a volume object, a plurality of snapshot objects, and a plurality of data bucket objects;
the volume object pointing to snapshot objects each corresponding to a snapshot created for the volume,
each of the snapshot objects comprising self-describing metadata that is used to restore the snapshot object back to the volume or other storage volume, and a list of one or more data bucket objects for the snapshot, wherein, for incremental snapshots, the one or more data bucket objects each include identifications of data blocks that represent changes made to the data in the volume since a prior snapshot, and
each data bucket object having a list of one or more data blocks and including data representing the snapshot corresponding to the snapshot object pointing to the data bucket object.
